(19) United States
(12) Patent Application Publication
(10) Pub. No.: US 2011/0245967 A1
(43) Pub. Date: Oct. 6, 2011

(54) Secure Method for Delivering Regulated Items Including Drugs to a Patient

(76) Inventors: Manish S. Shah, West Caldwell, NJ (US); Ray J. Difalco, Ridgewood, NJ (US)

(21) Appl. No.: 12/755,014

(22) Filed: Apr. 6, 2010

(51) Int. Cl. G06F 17/00; G06F 17/30

(52) U.S. Cl. 700/236; 700/237; 707/802; 707/E17.005

(57) ABSTRACT

The present invention is generally directed to a method of dispensing regulated items, particularly drugs, directly to the patient via a dispensing system, without pharmacist intervention, that reduces human error associated with dispensing regulated items wherein a manufacturer or distributor of a regulated item establishes a dispensing system in communication with a data base wherein a prescriber is registered and enters patient data such as which regulated item is prescribed for the patient, characteristics such as sex, age, height, weight, etc., any other drugs the patient is currently taking or has a prescription for, any allergies to any particular drugs, substances, components, etc., reliable data for verifying the identity of the patient, and subsequently dispensing a regulated item directly to the patient from said dispensing system without pharmacist intervention, including communicating any necessary educational or instructional information to the patient concerning the regulated item and verifying the steps to the data base.

### BACKGROUND OF THE INVENTION

1. Field of the Invention

The present invention relates to an apparatus and method for securely dispensing regulated items, including drugs, to patients without the need of a pharmacist. More specifically, the invention relates to a secure method for dispensing highly regulated items to a patient by dispensing the item directly from the manufacturer or distributor to the patient. For example, the scope of the present invention includes dispensing highly regulated teratogenic drugs such as thalidomide to patients, direct from the manufacturer or distributor. No pharmacist is necessary. The invention further relates to a method by which a doctor may prescribe regulated items such as drugs, syringes, IUDs, etc., to a patient and ensure that potential mistakes at the pharmacy are eliminated by use of a dispensing system located in the prescribing doctor's office, or in a hospital, or in a clinic or other medical facility.

Additionally, the present invention relates to an apparatus located in a doctor's office hospital, clinic or other medical facility that dispenses proper amounts of prescribed drugs or other regulated items to the patient. The apparatus may optionally provide drug specific instructions to patients and/or verify the identity of patients. Still further, the present invention may optionally relate to the use of a radio frequency identification device to track particular lot numbers of dispensed items. All of this is accomplished without the use of a pharmacist.

2. Description of Related Art

Of the many drugs or medical devices, such as syringes or IUD's, available by prescription today, many pose significant health risks if dispensed or used improperly, and thus they are regulated. For example teratogenic drugs are useful in treating many different symptoms, but care must be taken in their use. Of particular interest is thalidomide, due in part to its utility for treating certain conditions but its activity as a highly teratogenic compound. As such, the prescribing and use of thalidomide is highly regulated. A need exists for a method and apparatus to deliver thalidomide to patients in an efficient, secure manner that complies with the many regulations imposed by the FDA.

Thalidomide is a sedative-hypnotic, and multiple myeloma medication. The molecule of thalidomide is racemic—it contains both left- and right-handed isomers in equal amounts. The (R) enantiomer is effective against morning sickness. The (S) enantiomer is teratogenic and causes severe birth defects. One of the main obstacles for using thalidomide in a pharmaceutical capacity is that the (R) and (S) enantiomers can interconvert in vivo. So, if pure (R)-thalidomide is given to a person it can and will partially convert to (S)-thalidomide. Thus, both isomers will be present and giving only the (R) enantiomer to a female patient will not eliminate the potential for birth defects in a pregnant women.

Continued research of thalidomide has led to the discovery that it possesses anti-inflammatory properties and is useful to treat various symptoms and conditions. It was discovered that thalidomide was an effective treatment for people who were suffering from erythema nodosum leprosum, a skin condition caused by leprosy. Thalidomide acted as a powerful pain reliever and provided these people with some relief from the painful symptoms caused by their condition.

Research has also found that thalidomide reduces the levels of TNFα in patients, and subsequent research has shown that it is effective in multiple myeloma. As a result of the continued research into the advantages and benefits of thalidomide, the FDA has approved thalidomide for use in treating multiple myeloma.

It can be easily seen that despite its checkered past, potential side effects, and tendency to cause severe birth defects, thalidomide remains viable as a pharmaceutical compound, if proper care in its use and handling is followed. Thus, companies are manufacturing thalidomide and doctors are prescribing it to their patients. However, due to thalidomide's potential for causing birth defects, the distribution of thalidomide is permitted only under tightly controlled conditions. The FDA required that manufacturers establish a method for distributing thalidomide that would ensure the safety of patients and prevent the risk of pregnant women receiving thalidomide.

The S.T.E.P.S.® program is a rigid control that includes limiting prescription and dispensing rights only to authorized prescribers and pharmacies. In addition, patients are required to undergo extensive patient education about the risks associated with thalidomide. Furthermore, patients who are prescribed thalidomide must undergo periodic pregnancy tests and have their names placed on a patient registry.

The moniker S.T.E.P.S.® stands for System for Thalidomide Education and Prescribing Safety. The S.T.E.P.S.® program was developed because of the toxicity associated with fetal exposure to thalidomide and to minimize the chance of fetal exposure to thalidomide. S.T.E.P.S.® involves regulations covering patients, prescribers and pharmacists.

Along with the stringent regulation for prescribing thalidomide, concerns exist for the manner in which thalidomide is provided to the patient once the prescribing physician has issued a prescription. As with any potentially dangerous substance, dangers exist in the dispensing of thalidomide. Indeed, the potential consequences of an error at a dispensing pharmacy are severe. Errors stemming from pharmacies are a legitimate concern in the dispensing of dangerous and highly regulated drugs such as thalidomide. In a recent investigation for its “20/20” television news series, ABC News reported that many prescriptions are not even filled by pharmacists but by pharmacy technicians who are often just high school students. Pharmacists are supposed to then check each prescription, but this does not always happen. As with any industry, human error can have devastating results.

There are as many as 7,000 deaths annually in the United States from incorrect prescriptions, according to Carmen Catizone of the National Association of Boards of Pharmacy. According to Catizone, as many as 5 percent of the 3 billion prescriptions filled each year are incorrect. Approximately 770,000 patients per year are injured by medication errors. Statistics on pharmacy errors are difficult to track because neither the federal government nor 46 of the 50 states require drug stores to report their errors. However, since the number of prescriptions is expected to climb, errors are bound to increase. Because all errors are human errors, human intervention should be eliminated where possible. The S.T.E.P.S. program does not eliminate any human intervention.

There have been many patents that deal with automatically dispensing drugs. For example, U.S. Pat. No. 6,230,927 to Schoonen et al., discloses a drug dispenser that automatically dispenses a prepackaged drug. However, Schoonen does not disclose a secure system for restricting access using a patient's fingerprints. Also, Schoonen does not disclose a method for dispensing drugs that provides educational and informational material to patients.

Also, U.S. Pat. No. 6,256,967 to Hebron et al. teaches and discloses a robotic apparatus for filling and dispensing prescription drugs. Hebron does not disclose a secure manner for patient identification. Also, Hebron does not disclose a method to provide educational materials and information to patients. Rather, Hebron is an apparatus by which drugs are selected and automatically dispensed into containers and provided to the operator of the apparatus.

U.S. Pat. No. 6,045,501 to Elsayed et al. discloses registering prescribers and pharmacies in a computer readable storage medium. Elsayed also contemplates registering patients in the computer readable storage medium and identifying from the patient information those patients that may become pregnant or who may impregnate another person. In addition, Elsayed provides a manner to deliver educational materials to patients, but does not disclose who provides the materials. Thus, Elsayed teaches a method to educate patients on the risk of certain drugs and identifies those patients for whom a drug is contraindicated (specifically teratogenic drugs and more specifically thalidomide). Once the patients are cleared to receive the drug, the pharmacy is authorized to dispense the drug to the patient.

The patent to Elsayed et al. does not, however, provide a means to verify the identity of the patient via fingerprints. Also, Elsayed does not teach that a dispensing system may dispense the drugs. Further, Elsayed does not teach that the patient can obtain the prescribed drug in multiple locations through the use of a multiple dispensing systems. Further, Elsayed does not teach the use of radio-frequency identification (RFID) to track the dispensed product.

Thus a need exists for a method to decrease the potential for errors to occur in dispensing regulated items to patients by eliminating human intervention. A need also exists to dispense the regulated item directly to the patient and to avoid any unwanted use of the regulated item. Still further, a need exists for a method of dispensing thalidomide that ensures patients receive educational material and instructions regarding thalidomide or the regulated item. Optionally, a need exists for a method of delivery of thalidomide that will comply with the requirements of the S.T.E.P.S.® program. Optionally, a need exists for a method of using an RFID to tract the dispensed item, thereby matching the lot number with the name of the patient, to help with any recall situation. The RFID tag could be placed in the container holding the regulated item. This helps to recover the item if it was stolen and misused. Optionally, a need exists for a method to prevent dispensing the drug in the event of tampering. Optionally, the patient can return any unused portion of the drug to the kiosk, instead of throwing the remainder into trash. Video monitoring of the kiosk creates a record that the drug was picked-up by the patient. Optionally, a proximity sensor located on or near the kiosk ensures that a patient trying to use the kiosk, but gets distracted, and walks away, that no one else can use the kiosk and complete the transaction. Optionally the kiosk can notify the insurance company to recover the payment due directly form the insurance and notifies the doctor of the patient's receipt of the regulated item. Optionally, the kiosk can inform the patient and doctor, in the event, someone tries to use the patient's identity to obtain regulated drugs. Thus the kiosk can accomplish notification via fax, email, or phone.

### BRIEF SUMMARY OF THE INVENTION

In the broadest sense, the present invention is directed to a novel delivery system for regulated items. In particular, the present invention is related to a delivery system for drugs, particularly dangerous and highly regulated drugs. As can be easily contemplated, however, the present invention can be used to dispense any number of regulated items, such as syringes, IUDs, etc. Thus, when the term “regulated item” is used herein, it is to be understood that regulated item means items whose distribution is somehow overseen by a governmental entity or administrative body including the DEA, CDC, etc. Thus, regulated items include, but are not limited to, such items as drugs, syringes, intrauterine devices, etc. More specifically, the present invention is directed to a method and apparatus for dispensing teratogenic drugs such as thalidomide. Still further, the present invention discloses a delivery system for thalidomide that prevents dispensing of thalidomide to persons whose ingestion of the drug will pose a risk of birth defects in children. Moreover, the present invention provides a method to ensure that only the patient prescribed thalidomide is able to obtain the drug. Still further, the present invention is directed to a method to eliminate human error in the dispensing of regulated items such as thalidomide. Further, the present invention is directed to a method that ensures the ability to educate and instruct patients regarding thalidomide before dispensing the drug.

The present invention is generally directed to a method of dispensing regulated items, particularly drugs. The method involves registering prescribers, such as a doctor, nurse, or physician's assistant, in a data base, who are authorized to prescribe regulated items like drugs. Also, the method involves maintaining a dispensing kiosk that is in communication with the data base. The kiosk includes means to display educational or instructional information, and optionally means for verification of patient identity. Also, the invention involves registering patients in the data base, including data on: the particular drug or drugs prescribed for the patient, the patient's characteristics such as sex, age, height, weight, etc., any other drugs the patient is currently taking or has a prescription for, any allergies to any particular drugs, substances, components, etc., of the patient, and optional reliable data for verifying the identity of a patient including fingerprints, eyeball scans, retinal scans, DNA profiles, or correctly answering a set of personal question the answers of which are known only to the patient. Upon successful optional verification, the kiosk will communicate educational or instructional information to the patient prior to dispensing drugs. Once the information has been communicated to the patient, the kiosk will dispense the prepackaged common prescription size or quantity of drug to the patient and optionally record data regarding the dispensing of the drug to the patient, such as the lot number or RFID number, date time etc. This eliminates the pharmacist and any potential human error.

The present invention optionally is further directed to a method wherein the kiosk will communicate data regarding the dispensing of drugs to the patient's prescriber's office and to a patient's insurance company.

The present invention is still further directed to a method by which dispensed items are tracked by radio-frequency identification (RFID), to assure high quality (no old drugs), to aid in recall situations, to help identify stolen and potentially misused regulated items.

The present invention is also directed to a method of including tracking how many times a patient is prescribed and receives a regulated item. Such information on tracking can include information regarding quantity, strength, and lot number of a regulated item. Tracking this information allows a prescriber or other interested entity to monitor possible abuse of a regulated item.

The present invention is specifically directed to a method of securely dispensing thalidomide.

The present invention is further directed to providing a method further comprising the step of optionally verifying the patient's identity after the educational or informational information is presented, to ensure the patient has completed the full educational program. In this regard, the patient may be required to acknowledge understanding the educational program by actively responding to a question (clicking on the “yes” button). This ensures that the patient has reviewed and understands the educational and informational materials prior to dispensing the drug.

Also, the present invention is directed to a method in which the kiosk will provide a warning to a patient if the comparison of the patient's prescription with the patient's information determines that a conflict may exist. Also, the kiosk can notify the patient's prescriber of a potential conflict with the patient's prescription.

The present invention is further directed to a method wherein the drug manufacturer maintains a centralized computer data base, the centralized computer data base preferably communicating with a plurality of kiosks in different locations. The manufacturer will maintain the data base in order to verify drug expiration dates and when to re-supply the kiosk with fresh drugs.

The present invention further contemplates a kiosk wherein the educational and informational materials are videos shown on a display means on the kiosk. Also, the kiosk can have different educational and informational materials for different items or drugs. The kiosk can still further provide an interactive interface on the kiosk for use by the patient. This will allow the kiosk to provide an educational and informational presentation that is interactive with the patient. The present invention also contemplates a kiosk that can provide a means to accept payments from patients.

The present invention further contemplates maintaining the computer data base and deleting from the computer data base prescribers who fail to adhere to specific requirements.

The present invention is optionally directed to a method by which dispensed items are tracked by product lot number directly identified to the patient.

The present invention is optionally further directed to a method by which dispensed items are monitored by video, thus identifying the patient to the drug dispensed.

The present invention further contemplates arranging for the prescriber to provide an identification card to the patient, such identification card containing information unique to the patient.

The present invention is also optionally directed to a method whereby if in the process of patient's identification, a person has acquired the card illegally, the machine will shut down the use to the that person and authorities will be notified as to a possible theft and misuse of drugs.

The invention is still further directed to a method of dispensing a regulated item, particularly a drug, that includes maintaining a regulated item in a dispensing system by a manufacturer or distributor of the regulated item. The dispensing system is configured to be in communication with a data base. A prescriber is registered in said data base and is authorized to prescribe the regulated item to a patient. The prescriber registers a patient in the data base with such registration information as the specific regulated item prescribed for the patient, the patient's characteristics such as sex, age, height, weight, etc., any other drugs that the patient is currently taking or has a prescription for, any allergies to any particular drugs, substances, components, etc., of the patient, and reliable data for verifying the identity of the patient. The system further confirms that the regulated item should be dispensed directly to the patient without pharmacist intervention. However, if any of the verification steps should fail, or if other events are triggered, the system will withhold the regulated item and notify the prescriber that the regulated item was not dispensed because of a failure of one or more confirming steps.

The present invention also contemplates a method step of alerting the data base of the reason or reasons for not dispensing the regulated item in the event that the regulated item was withheld.

The invention is also further directed to a method of tracking the patient by the regulated item use. Thus, if the patient is prescribed the same regulated item by different prescribers, the system can alert to a possible motivation of the patient to advert the intended use of the regulated item. In this event, the regulated item will not be dispensed and an alert will be sent to the data base.

### DETAILED DESCRIPTION OF THE INVENTION

The present invention is directed generally to methods of delivery of regulated items, particularly drugs, to patients through a controlled, secure, automated, and reliable system. While the invention is primarily described in terms of thalidomide, it is meant to cover all regulated items.

More specifically, the present invention is directed to a method for delivering drugs, in particular teratogenic drugs, to patients. As used herein, the term “drug” can refer to any pill, liquid, capsule, tablet, powder or other substance which is intended for use in the diagnosis, cure, mitigation, treatment or prevention of disease, or to affect the structure or function of the body. Moreover, drug, as used herein, can refer to any regulated item such as a syringe, intrauterine device, or other item for which a prescriber must issue a prescription.

The methods disclosed herein can be advantageously used to both educate patients who are using a particular drug, and to reinforce the actions and behaviors of patients who are already taking the drug. Further, the methods herein ensure that prescribers are able to correctly and consistently follow the acceptable guidelines for prescribing a particular item or drug. Continual education and reinforcement of positive actions and behaviors is necessary to ensure that prescribers are able to properly prescribe and dispense a particular drug. In addition, continual education and reinforcement of positive and proper actions and behaviors on the part of the patients is equally important to guard against injuries.

The methods disclosed herein are optionally fully compliant with the S.T.E.P.S.® program regulating the dispensation of thalidomide. The steps disclosed serve to properly ensure the safety of not only the patient, but the prescribers as well. Further, the methods disclosed herein provide opportunities to educate the patient regarding thalidomide and its dangers and risks. Still further, the methods described herein provide a method to prevent the dispensing of drugs in the event of tampering with the dispenser.

A wide variety of educational materials may be utilized with the disclosed methods, thereby covering all prescription drugs. And the materials may be regularly updated as often as the manufacturer or distributor desires. Such variety of educational materials is essential in order to ensure proper prescribing, dispensing and patient compliance with acceptable and proper procedures. For example, a variety of literature including such things as product information labels, educational brochures, pamphlets, flyers, continuing education monographs, videotapes and the like which may describe the risks and benefits associated with taking the particular drug that a patient is prescribed can be utilized with the present invention. The present invention contemplates the use of videos to instruct patients on the proper use and risks of such regulated items as thalidomide.

In addition to providing educational material and protection for patients regarding the particular drug the patient is prescribed, the methods described herein also serve to safeguard patients for whom a particular drug is contraindicated. As used herein, the term “contraindicated” refers to any condition in a patient, such as an allergy or hazardous interaction with another drug, which renders a particular line of treatment, including the administration of one or more drugs, undesirable or improper. For example, a woman who is potentially pregnant or who is attempting to become pregnant cannot use any drug or substance that is a known teratogen. Other drugs cannot be taken with alcohol. Thus an alcohol based drug should not be taken with such drugs. In particular, the methods described in the present invention are especially advantageous for the delivery to a patient of a teratogenic drug, since the present invention cross-references a patient's prescription with data on the patient. Thus, by use of the herein described methods, a teratogenic drug may be dispensed to a proper patient while simultaneously and substantially avoiding the delivery of the drug to a fetus.

The drug delivery methods of the present invention preferably involve, inter alia, first registering in a computer data base prescribers who are qualified to prescribe the involved drug. Each prescriber who has completed the necessary training to prescribe and dispense, for example, teratogenic drugs like thalidomide, would have their information entered into the computer data base. Once registered in the computer data base (or any readable storage medium), the prescriber would become eligible to prescribe the drug to patients in need of the drug. Moreover, a requirement for registration optionally could be that a prescriber review certain educational materials regarding that particular drug, including all requirements of the S.T.E.P.S® program.

In addition to the registration of prescribers into a data base, it is contemplated that hospitals and pharmacies would also be able to be registered in the data base as a known location for a dispensing kiosk. The data base in which the pharmacies or hospitals or clinics are registered can be the same as, or different from the data base in which the prescribers are registered. As with the registration of the prescriber in the computer data base, the registration of the pharmacy or hospital as a host location may be contingent on the pharmacy completing various steps, including becoming familiar with the procedures of the S.T.E.P.S.® program, if such facilities wish to dispense teratogenic drugs like thalidomide from a kiosk or dispensing system. Once the pharmacy or hospital has complied with the regulations and or steps for registration, the drug manufacturer would register the pharmacy or hospital as a host location for a dispensing kiosk.

In addition to registration of the prescriber, the present invention contemplates registration of the patient in a data base. As discussed below, the registration of the patient is preferably carried out by the prescriber at the time of the patient's initial visit to the prescriber's office. The data base in which the patients are registered may be the same as, or different from the data bases in which the prescriber is registered. Once registered in the computer data base, the patient in need of a particular drug including, for example, a particular teratogenic drug like thalidomide, may be eligible to receive the drug upon fulfilling certain requirements. Generally speaking, in order to become registered in the computer data base and be eligible to receive the drug, the patient would be required to comply with various aspects of the methods described herein, all of which must comply with the S.T.E.P.S.® program. In preferred embodiment of the present invention, the prescriber would have a registration card or form filled out for the patient, which included information on the patient such as the patient's name, mailing address, date of birth, and the like. Additionally, information on the prescriber and any other drugs the patient was currently taking could also be entered on the patient registration card or form. The completed card or form may then be entered into the data base. It is contemplated that the registration of the patient into the computer data base may also be achieved, for example, by telephone. Thus, registration with the manufacturer or distributor will significantly reduce the risk that a single patient could end up with multiple prescriptions and registrations for the same drug. This ensures that a patient will not receive multiple doses of the same drug which could be harmful and/or ensures against misuse of the drug (selling the extra drug).

Upon setting up the kiosk (the dispensing system), the manufacturer or distributor of the regulated items would record by date, time, amount, lot number or any other appropriate information the supply of each drug in the kiosk, and would re-supply and exchange expired drugs at predetermined periodic intervals. This will ensure that sufficient quantities of the particular drug are available and that the drugs themselves are still within acceptable ages. In the event that the drugs expire, the manufacturer would replace the expired drug with a fresh batch to ensure that only proper drugs were dispensed to patients.

Once a patient seeks the advice of a prescriber and the prescriber decides that a specific drug would be beneficial to the patient, the prescriber will issue a prescription for that particular drug. The prescriber would then ensure that the patient completed the registration process for the particular drug and was registered in the computer data base maintained by the manufacturer or distributor. The prescriber would have a form or card for the patient to fill out upon being prescribed the drug. This form may optionally contain a semi-attached identification code card embedded within the form. This code card would also have embedded within the card itself a means to specifically track, using radio-frequency identification (RFID), the location of the card. This code card would also contain a means to specifically identify the patient and distinguish the patient from any other person. Such means could be, for example, a finger print reader or any of the other identification methods mentioned previously. The finger print reader would record the finger print of the patient when the patient completes the information on the form. The prescriber would then include such information as the drug the patient was to receive, the amount of the drug, the frequency of the patient's need to return to the kiosk for refills, and other pertinent information. This ensures that the manufacturer's computer data base contains accurate information regarding the patient and is able to accurately match the patient with the fingerprint and dispense the proper quantity of drug.

When the patient places his finger on the fingerprint sensor, the sensor reads the patient's finger and extracts the features (swirls and whorls) from the patient's fingerprint. The fingerprint reader then takes the data gathered from the scan of the patient's fingerprint (or some indicia thereof, such as the generation of a hash number based on the fingerprint) and stores the identifying information on the attached card. The prescriber could then insert the card into the manufacturer's or distributor's kiosk which would upload the identification information from the kiosk and transmit it to the manufacturer/distributor.

It is contemplated that each kiosk installed by the manufacturer will be able to communicate by any standard method with the manufacturer's or distributor's data base to receive updated information. Thus, a patient is not limited to one particular kiosk in one location. Rather, a patient could go to any of the manufacturer's kiosks and obtain their prescribed drugs. This mutual communication between kiosks and the data base ensures that each kiosk has the same, up-to-date information.

Once all the necessary information regarding the patient and the prescribed drug is entered into the data bases, the patient is ready to use the manufacturer's kiosk to obtain the prescription. Any regulated drug may be dispensed according to the described method, yet additional safeguards are available for dangerous drugs such as teratogens like thalidomide.

The present invention is able to comply with the S.T.E.P.S.® program by providing patients with the necessary education and instructions on the dangers of thalidomide prescriptions. Indeed, it is contemplated that the manufacturer will program the kiosk to present numerous, alternative information depending on what drug is being dispensed to a patient.

In a preferred embodiment, the patient will receive their prescription for thalidomide from the authorized prescriber. After the prescriber enters the patient's information, including fingerprint or other identifying information data, into the kiosk and thereby the manufacturer's or distributor's data base, the patient is ready to use the kiosk to obtain the thalidomide. The patient will take the card provided by the prescriber and insert it into the kiosk. The kiosk will read the card and call up the particular information regarding that patient including the prescription and fingerprint data. Optionally a video monitor will begin to observe the process. Once the kiosk has obtained the data on the patient from the manufacturer, the kiosk will instruct the patient to place a finger on a fingerprint scanner located on the kiosk itself. The kiosk will scan the patient's fingerprint and compare it to the fingerprint data stored in the data base. If the fingerprint of the person using the kiosk matches the fingerprint data contained in the computer data base, the kiosk will accept that the user is, indeed, the patient for whom the prescription is written. Upon a positive identification, the kiosk is programmed to continue and provide the required educational and informational material to the patient. If, however, the fingerprint does not match the fingerprint on the computer data base at the manufacturer, the kiosk will end the transaction and will not dispense any drug. Thus, the fingerprint or identifying information prevents any unauthorized user from accessing the drugs contained within the kiosk. It is contemplated that the kiosk or dispensing system could give a first error message and allow a re-test, when the scanner may be dirty, for example. This enables a patient to have a second chance. After several times of trying to complete the transaction and failing, an alert is sent to the manufacture or distributor, the patient, and then, possibly, the local authorities to investigate. Moreover, the kiosk is preferably equipped with an anti-tampering mechanism to ensure that the contents are inaccessible if the kiosk is severely damaged or any attempt to remove the kiosk from its location is detected.

Once the kiosk verifies the identity of the patient, the kiosk obtains the proper educational information from the manufacturer or distributor before dispensing the drugs to the patient. In the case of thalidomide, the patient is required to view an educational program regarding the risks of thalidomide. The kiosk is advantageously equipped with a monitor that can display videos and potentially play sounds so that educational and informational presentations can be presented to the patient. For privacy, ear-phones and curtains could be part of the kiosk. This ability to present an educational and informative video to the patient complies with the second step of the S.T.E.P.S.® program, educating patients. The educational video may be interactive with the patient. It may contain not only educational materials but information on the dangers associated with the particular drug, methods of handling, instructions on how to administer the drug, etc. Further, the kiosk may be programmed with presentations and or videos in multiple languages for patients who do not speak English.

An optional video monitor with a proximity sensor serves to ensure that the patient actually is present for the entire educational video and receives the benefit of the information contained therein. Also at this time the patient may be required to affirm that they understood the educational materials.

Once the kiosk has dispensed the drug to the patient, the kiosk communicates the fact that the drug has been dispensed, the date, the quantity, the time, and any other information the manufacturer/distributor desires to ensure compliance with the S.T.E.P.S.® program, and this information is stored in the data base. This accumulation of data regarding the drugs and patients allows the manufacturer to guard against overmedicating a particular patient. Further, the centralized records regarding the medication of the patient guard against the patient getting multiple prescriptions for the same drug.

It is further contemplated that the kiosk have a mechanism to attach and track a radio-frequency identification device (RFID) implanted in the dispensed items or drugs or identification card. The RFID will have a unique identifying tag by which the manufacturer can track the dispensed item by lot number. This will facilitate identification of dispensed items and the persons who obtained the items in the event of a recall. Still further, the RFID could be embedded in the packaging containing the dispensed drugs.

In addition to communicating with the manufacturer regarding the dispensing of the drugs to the patient, the kiosk may be programmed to communicate with any number of entities regarding the patient's receipt of the drug. For example, the kiosk could communicate with the patient's insurance company by sending a notification that the drug has been dispensed to the patient and send a bill to the insurance company. The kiosk can also be equipped with means to accept payments from patients. This could be via any known apparatus such as cash accepters and credit card scanners. Also, the kiosk could communicate with the patient's prescribing doctor's office that the patient has obtained the drugs. Thus, the prescriber can be notified that the patient has, in fact, obtained the drugs and/or allow the prescriber to bill the patient for the regulated items.

The above described embodiment of the present invention is by no means limiting in any respect. Indeed, many alternatives exist to the disclosed method. For example, technology now exists that will increase the assurances that the patient is the correct person before the kiosk will dispense the drug. Eyeball scans and retinal scans are now technologically advanced enough such that a prescriber could scan a patient's retina at the time the prescriber makes the diagnoses for a drug and enter the retinal scan, or indicia thereof into the data base instead of or in addition to the fingerprint scan. Furthermore, technology now exists whereby indicia of these identifiers can be used to accurately identify a person. Further, DNA scans are becoming more readily available and could be used as a means to identify a patient as well. Finally, any combinations of fingerprints, eyeball scans, retinal scans, DNA analyses, or indicia of these may work equally well to ensure that the proper person is obtaining the drugs.

Another advantage of the present invention is the ability for the kiosk to cross check information on the patient with a data base on available drugs. The kiosk has the ability to store large amounts of data on the patient and this data can be used to protect against any contraindicated drugs for the particular patient. For example, if the data on the patient indicates that the patient is allergic to sulfa containing drugs, the kiosk could retrieve this information from the computer data base prior to dispensing any drugs. If for some reason the prescriber did not know the patient was allergic to sulfa containing drugs and prescribed one, the kiosk would not dispense that drug to the patient. Instead, the kiosk could display a warning message and send a notice to the prescriber detailing the reason it did not dispense the drug. Further, in the case of thalidomide, the kiosk would be programmed not to dispense thalidomide to any female who may be or may become pregnant. Still further, the kiosk may be programmed with information relating to multiple drugs and possible hazardous drug interactions. Thus, if a patient obtained a prescription from one prescriber and another, incompatible prescription from another prescriber, the kiosk could recognize the danger. In the event that a hazardous drug interaction is indicated, the kiosk would not dispense the drug, display a warning, and send a notice to the prescriber's office.

Thus, it is clear that the registration into one or more computer data bases of the prescriber, hospital, clinic, or pharmacy, and patient, according to the methods described herein, provides a means to monitor and authorize distribution of potentially harmful drugs. This is especially important to safeguard against the dispensing of contraindicated drugs, including teratogenic drugs like thalidomide. As such, the computer data base maintained at the manufacturer's location can communicate with the kiosk can serve to deny access to, and prevent the dispensing of harmful or contraindicated drugs, including teratogenic drugs like thalidomide, to patients. In addition, the kiosk has the ability, through maintenance of the computer data base by the manufacturer, of denying use of the kiosk to pharmacies or prescribers who fail to abide by the regulations of the S.T.E.P.S.® program or the methods of the present invention, if teratogenic drugs are to be dispensed. As noted above, prescribers who are not registered in the computer data base will not be able to use the kiosk, and hospitals or pharmacies that are not registered may not use the kiosk. Similarly, patients who do not follow the described procedures will not be able to access the drugs and the kiosk will not dispense the drugs to these patients or unauthorized people.

Various modifications of the invention, in addition to those described herein, will be apparent to those skilled in the art from the foregoing description. Such modifications are also intended to fall within the scope of the appended claims.

What is claimed is:

1. A method of reducing human error associated with dispensing regulated items, particularly drugs, by eliminating pharmacist intervention comprising:
a. maintaining a regulated item in a dispensing system by a manufacturer or distributor of said regulated item, said dispensing system being in communication with a data base;
b. registering a prescriber in said data base who is authorized to prescribe said regulated item;
c. providing means for said prescriber to register a patient in said data base, such registration including data concerning:
i. said regulated item prescribed for the patient,
ii. the patient's characteristics such as sex, age, height, weight, etc.,
iii. any other drugs the patient is currently taking or has a prescription for,
iv. any allergies to any particular drugs, substances, components, etc., of the patient,
v. reliable data for verifying the identity of the patient;
d. dispensing said regulated item directly to the patient from said dispensing system without pharmacist intervention, contingent upon:
i. verifying the identity of the patient,
ii. analyzing the patient's prescription and comparing the prescription with the patient's information installed into said data base by the prescriber,
iii. communicating any necessary educational or instructional information to the patient concerning said regulated item, with verification to said data base.

2. The method of claim 1, further including means for tracking a product lot number of said regulated item to a patient by said dispensing system.

3. The method of claim 2, wherein said means for tracking is a radio frequency identification device (RFID).

4. The method of claim 1, wherein step (d) (iii) communicates said information to said patient via an audio/video monitor associated with said dispensing system.

5. The method of claim 1, wherein said step (c) includes the step of video monitoring of said patient upon using said dispensing system.

6. The method according to claim 1, wherein the verification of the patient's identity is confirmed by finger print, retinal identification, DNA, or identifying questions/answers.

7. The method according to claim 1, wherein said regulated item will only be dispensed after the complete communication of educational or instructional information is performed by said dispensing system and confirmed by the patient.

8. The method according to claim 1, further comprising communicating data regarding the dispensing of said regulated item to the patient's prescriber.

9. The method according to claim 1, further comprising communicating data regarding the dispensing of said regulated item to a patient's insurance company.

10. The method according to claim 1, wherein said regulated item is thalidomide.

11. The method according to claim 1, further comprising the step of requiring the patient to acknowledge that he/she has reviewed and understands the educational and informational materials prior to dispensing said regulated item.

12. The method according to claim 8, further comprising notifying the patient's prescriber that a potential conflict with the patient's prescription is determined.

13. The method according to claim 1, further comprising maintaining a centralized data base, said data base communicating with a plurality of dispensing systems in different locations.

14. The method according to claim 13, wherein said locations are hospitals, clinics, prescribers' offices, and/or pharmacies.

15. The method according to claim 1, further including maintaining said regulated item by verifying said regulated item's expiration date and re-supplying said dispensing system with fresh regulated items.

16. The method according to claim 1, wherein the educational and informational materials are different for different items.

17. The method according to claim 1, further comprising providing an interactive interface on the dispensing system for use by the patient.

18. The method according to claim 17, further comprising providing an educational and informational presentation that is interactive with the patient.

19. The method according to claim 1, further comprising providing said dispensing system with a means for accepting payments from patients.

20. The method according to claim 1, further comprising attaching a unique identification and tracking device on the regulated item to link the lot number to the patient's identification.

21. The method according to claim 1, further including arranging for the prescriber to provide an identification card to the patient, such identification card containing information unique to the patient.

22. The method according to claim 1, further comprising providing means for analyzing an identification card, provided by said prescriber at the time of visit, identifying the patient to said dispensing system and specifying said regulated item prescribed by said prescriber.

23. The method according to claim 22, further comprising returning to the patient said identification card for future use.

24. The method of claim 1, further including tracking how many times a patient is prescribed and receives said regulated item by quantity, strength, and lot number to monitor possible abuse of said regulated item.

25. A method of dispensing a regulated item, particularly a drug, comprising:
a. maintaining a regulated item in a dispensing system by a manufacturer or distributor of said regulated item, said dispensing system being in communication with a data base;
b. registering a prescriber in said data base who is authorized to prescribe said regulated item;
c. providing means for said prescriber to register a patient in said data base, such registration including data concerning:
i. said regulated item prescribed for the patient,
ii. the patient's characteristics such as sex, age, height, weight, etc.,
iii. any other drugs the patient is currently taking or has a prescription for,
iv. any allergies to any particular drugs, substances, components, etc., of the patient,
v. reliable data for verifying the identity of the patient;
d. confirming said regulated item should be dispensed directly to the patient without pharmacist intervention;
e. withholding said regulated item and notifying said prescriber that said regulated item was not dispensed because of a failure of one or more confirming steps.

26. The method of claim 24, further comprising alerting said data base of the reasons for not dispensing said regulated item in the event that said regulated item was withheld.

27. The method of claim 24, further comprising tracking the patient by said regulated item use where if the patient is prescribed the same regulated item by different prescribers to advert the intended use of said regulated item, said regulated item will not be dispensed and an alert will be sent to said data base.
